(19) United States
(12) Patent Application Publication
(10) Pub. No.: US 2011/0003523 A1
(43) Pub. Date: Jan. 6, 2011

(54) AGENT FOR THE HYDROPHILISATION OF AN ORGANIC PLASTIC MATERIAL

(75) Inventors: Pascal Herve, West Windsor, NJ (US); Roland Durand, Saint Bonnet De Mure (FR); Sylvie Touzet, Antony (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Rhodia Operations

(21) Appl. No.: 12/739,681

(22) PCT Filed: Oct. 16, 2008
(86) PCT No.: PCT/EP08/63959

§ 371 Date: Sep. 14, 2010

(30) Foreign Application Priority Data
Oct. 24, 2007 (FR) 0707459

(51) Int. Cl. C08F 8/40; D03D 15/00; D04H 13/00

(52) U.S. Cl. 442/181; 525/340; 442/327

(57) ABSTRACT

The invention relates to an agent for the hydrophilisation of an organic plastic material such as a thermoplastic polymer, wherein said hydrophilisation agent is selected from optionally polyalkoxylated ester phosphates in their acid form or salt form. The invention also relates to objects made of thermoplastic polymers having surfaces hydrophilised by the agents of the invention.

The invention relates to an agent for the hydrophilization of an organic plastic such as a thermoplastic polymer, to its use in said plastic and to a process for preparing organic plastics, in particular thermoplastic polymers, that make it possible to obtain a hydrophilic surface behavior of the articles manufactured with said plastics.

The invention also relates to the articles made of thermoplastic polymers having surfaces hydrophilized by the agents according to the invention.

Organic plastics such as polyesters, polyamides, polyolefins and more particularly polypropylene normally have very hydrophobic surfaces, which is a drawback for many applications of articles manufactured from these plastics.

For example, porous or discontinuous voiles or films, manufactured from polypropylene or polyester yarns or fibers, obtained by what is known as the nonwoven technique, which will be known under the generic term “nonwoven textile surface”, have an essentially hydro-phobic surface behavior. This behavior requires that they are surface-coated, as a post-treatment, with soluble surfactant compositions in order to be able to be used in applications such as hygiene, wiping, diaper, etc. applications.

This surface treatment has the disadvantage of not being durable and also of allowing the surfactant used in the treatment layer to dissolve when in contact with water. This phenomenon should particularly be avoided in body hygiene applications such as diapers. This is why the process for incorporating the hydrophilizing agent into the plastic is particularly advantageous for this type of application and is described in patents WO 2006/056706 and WO 2006/056707.

Also, the hydrophilization of the surface of articles is desired in other applications, for example those concerning bulky articles such as parts for the automotive industry.

It is desired to be able to paint these parts, and plastics such as polypropylene are not able to be painted. In this case, treatment of the surface with a hydrophilic or amphiphilic coating is not a viable solution because the hydrophilizing treatment is neither durable nor adherent.

In another type of application, hydrophilicity is desired because it enables the surface in question to be cleaned with water. In particular, containers for food use made of polyolefin (PE, PP) present a cleaning problem when it is desired to wash them in an automatic dishwasher. Whereas all the glass or ceramic utensils emerge clean and dry from the dishwasher, utensils made of polyolefins emerge still wet, with water droplets that are not spread out due to the high hydrophobicity of the utensils and containers in question.

Finally, the hydrophilicity of packaging or films made of polypropylene is also desired to prevent them from getting dirty, and prevent the deposit of dust, and condensation, during storage of products packaged in polypropylene films in retail outlets. At this level, the hydrophilicity contributes to the non-adhesion of greasy dirt or dust, but also to the flow of static electricity charges responsible for certain types of soiling.

One of the objectives of the present invention is therefore to find a means for preparing a plastic which has a more hydrophilic surface, the hydrophilicity possibly being obtained either by a process of incorporation into the molten plastic or by a surface treatment.

Another objective of the invention is to propose hydrophilizing agents and the use thereof in the plastic that makes it possible to obtain a more hydrophilic surface.

These objectives, and others, are achieved by the present invention, which proposes the use, as an agent for the hydrophilization of an organic plastic, in particular a thermoplastic polymer, of a compound chosen from optionally polyalkoxylated phosphate esters, in acid form or in salt form.

Another subject of the invention is a composition comprising a plastic, especially a thermoplastic polymer, and a hydrophilizing agent chosen from optionally polyalkoxylated phosphate esters, in acid form or in salt form.

It also relates to a process for preparing the thermoplastic polymer in which the hydrophilizing agent has been either incorporated into the bulk of the plastic or else has been deposited at the surface of said plastic. It also relates to the additives used to obtain this surface hydrophilicity, said additives being either blended and co-melted with the plastics (addition of the additive in the bulk), or via application to the surface of said plastics.

The molten blends of thermoplastic polymers and of additives are shaped by any conventional means (extrusion, injection molding, film stretching, etc.) in order to obtain the desired articles. On the other hand, the surface application treatment is carried out directly on the already shaped and finished article.

The expression “thermoplastic polymer” is understood to mean, more particularly, polyesters, polyamides and polyolefins such as polyethylene and polypropylene.

The hydrophilizing agent is chosen from optionally polyalkoxylated phosphate esters, in acid form or in salt form. The hydrophilizing agent corresponds, more particularly, to the following formula:

[R″—(O-A″)_{y}—O]_{x″}P(═O)(OM)_{x′},

where:

M is chosen from a proton, a cation or a mixture, for example H⁺, K³⁰, Na³⁰;

x′ and x″ are equal to 1 or 2, on condition that the sum of x′ and x″ is equal to 3;

y, which is an average value, is between 0 and 100, preferably between 1 and 15;

the R″ groups, which are identical or different, represent a hydrocarbon-based radical comprising 1 to 35 carbon atoms; and

the A″ groups, which are identical or different, represent a linear or branched alkylene radical, comprising 2 to 4 carbon atoms.

The R″ groups, which are identical or different, represent a C₁-C₃₅, preferably C₅-C₂₀, alkyl, alkylaryl, polyalkylaryl or (polyarylalkyl)aryl group, (the alkyl groups possibly being linear or branched, saturated or unsaturated). As regards the polyalkoxylated compounds, these may be polyethoxylated compounds. The degree of alkoxylation may especially be between 0 and 100; preferably between 1 and 15.

More particularly, the R″ groups are an alkyl or alkenyl radical bearing one or more ethylenic unsaturated groups, which are linear or branched, containing 8 to 26 carbon atoms. As examples of such radicals, mention may especially be made of stearyl, oleyl, linoleyl and linolenyl radicals. In addition, the R″ radicals, which are identical or different, may be aromatic radicals bearing alkyl, arylalkyl or alkylaryl substituents, these radicals comprising 6 to 30 carbon atoms. As examples of such radicals, mention may be made, inter alia, of nonylphenyl, monostyrylphenyl, distyrylphenyl and tristyrylphenyl radicals.

More particularly, the (O-A″) groups, which may or may not be identical, correspond to an oxyethylenated, oxypropylenated or oxybutylenated radical, or mixtures thereof. Preferably, said group corresponds to an oxyethylenated and/or oxypropylenated radical.

Useful hydrophilizing agents are sold, in particular, by Rhodia under the names Lubrhophos® and Rhodafac®.

It is mentioned that the hydrophilizing agents are preferably present in the formulation in salified, neutralized form. The neutralization may be obtained using any organic or mineral base, for example NaOH, or KOH (M═K⁺, Na⁺). Use may especially be made of organic amines, for example optional polyalkoxylated fatty amines. More details are given below.

The amount of hydrophilizing agent introduced into the polymer in the bulk or at its surface is such that the weight ratio between the hydrophilizing agent and the thermoplastic polymer is between 0.5/99.5 and 10/90, more specifically between 1/99 and 3/97.

The phosphate ester compound may be included in a composition comprising the plastic.

The thermoplastic polymer is chosen from polyesters, polyamides or polyolefins such as polyethylene and polypropylene.

The invention also relates to the hydrophilizing agents used to obtain a surface hydrophilicity, said additives being blended and co-melted with the plastics (addition of the additive in the bulk).

The molten blends of thermoplastic polymers and additives are shaped by any conventional means (extrusion, injection molding, film stretching, etc.) to obtain the desired articles.

According to a first embodiment, the hydrophilizing agent is blended and co-melted with the plastic, preferably a thermoplastic polymer.

The thermoplastic polymer is generally present in the form of solid granules.

The hydrophilizing agent may be blended at room temperature with the polymer granules then introduced into a mixing device brought to temperature.

The hydrophilizing agent may also be introduced into the mixing device in which the polymer is already present in the melt state.

The hydrophilizing agent may be blended with the thermoplastic polymer, optionally with other ingredients, for example fillers or stabilizers, by blending with the thermoplastic polymer before melting, by direct introduction into the molten thermoplastic polymer, and/or via a masterbatch.

The mixing device at temperature may be a chamber equipped with rotors and heated by a flow of fluid. It is thus referred to as an internal mixer. This is a “batch” process. Mention may be made, for example, of a Brabender mixer. After cooling, a preform of solid material is recovered which can be shaped in a mold by compression molding.

The mixing device at temperature may also be an extruder in which the material is conveyed, heated and kneaded by rotating screw components. This is a “continuous” process. Mention may be made, for example, of a Werner ZSK30 extruder. A rod of molten material is recovered which is cooled then cut to obtain granules.

These granules may then be injection-molded in the form of test pieces or finished materials.

When the hydrophilizing agent is in solid form, that is to say in the form of a powder, flakes or granules, it is then incorporated easily as indicated above.

When the hydrophilizing agent is in liquid form, said liquid comprising 100% of hydrophilizing agent, or else the hydrophilizing agent being in solution in a solvent, there are several possibilities for the incorporation thereof.

It is possible to directly incorporate the liquid, with or without evaporation of the solvent depending on whether the boiling point of the liquid (hydrophilizing agent or solvent) is below or above the conversion temperature (around 180° C.)

It is also possible to impregnate this liquid into a porous support, such as for example a precipitated silica in order to obtain a powder. This powder may then be shaped to facilitate its use.

Mention may be made, for example, of document FR 2 843 122 which describes means for incorporating liquids into thermoplastic polymers.

Therefore, another subject of the present invention is a process for preparing a composition comprising the thermoplastic polymer and the hydrophilizing agent, characterized in that the hydrophilizing agent and the thermoplastic polymer are melt-blended.

Therefore, another subject of the present invention is a process for preparing a composition comprising the thermoplastic polymer and the hydrophilizing agent, characterized in that the hydrophilizing agent is blended with the thermoplastic polymer, optionally with other ingredients, for example fillers or stabilizers, by blending with the thermoplastic polymer before melting, by direct introduction into the molten thermo-plastic polymer, and/or via a masterbatch.

The molten blends of thermoplastic polymer and hydrophilizing agent may be shaped by any conventional means (extrusion, injection molding, film stretching, etc.) in order to obtain the desired articles.

The molten blends of thermoplastic polymer and hydrophilizing agent may thus be made into the form of a powder to be molded, in the form of an extruded and/or blow-molded and/or injection-molded article, in the form of a film, or in the form of fibers, yarns or filaments, optionally assembled as a woven or nonwoven textile surface.

According to a second embodiment, the hydrophilizing agent may be applied to all or part of a surface of the plastic by any appropriate method. This method may depend, in particular, on the form of the articles whose surface is to be treated, on the size of the article, on the configuration of the factory for manufacturing the article, on the configuration of the center for treating the article, and/or on the equipment available or that can be adapted to the manufacturing or treatment line.

The application may especially be carried out by dip-coating, or by spraying, in an open or enclosed setting.

The hydrophilizing agent is preferably applied in the form of a solution. This solution preferably comprises a solvent, and a polyvinyl alcohol. The solvent may be a mixture of several solvents. It is preferably an aqueous solution (the solvent is water). As other solvents that may be used, alone or as a mixture with themselves or with water, mention is made of alcohols such as ethanol or isopropanol.

The concentration of the polyvinyl alcohol is preferably between 0.01 and 10% by weight, preferably between 0.2 and 5% by weight. This concentration may especially be adjusted as a function of the application method, the amount of treatment desired, and/or the desired effectiveness.

The invention also relates to the applications of these articles made of thermoplastic polymers having hydrophilized surfaces.

As examples of articles made of thermoplastic polymer having a hydrophilized surface, mention may especially be made of a nonwoven textile surface comprising fibers based on a composition according to the invention.

Mention may be made, in particular, of a nonwoven textile surface comprising fibers based on a composition according to the invention in which the thermoplastic polymer is based on polypropylene.

This textile surface may be used in the manufacture of diapers for babies, of feminine hygiene products or of products for the treatment of adult incontinence.

As examples of articles made of a thermoplastic polymer having a hydrophilized surface, mention may also be made of bulky articles such as parts for the automotive industry.

As examples of articles made of a thermoplastic polymer having a hydrophilized surface, mention may also be made of containers for food use made of polyolefin (polyethylene or polypropylene).

As examples of articles made of a thermoplastic polymer having a hydrophilized surface, mention may also be made of packaging or films made of polypropylene.

The invention finally relates to the use of optionally polyalkoxylated phosphate esters as defined previously as hydrophilizing agents for a composition comprising an organic plastic, in particular a thermoplastic polymer.

The surface hydrophilicity is evaluated by measurement of the contact angle between a drop of purified, distilled water and said surface. A drop of distilled water of calibrated size is deposited under standardized and repetitive conditions on the surface to be studied. It spreads out or retracts to a greater or lesser degree depending on the hydrophilicity of the surface, and with a suitable apparatus, it is possible to measure the angle formed by the deposited drop and the surface.

The apparatus used may be, for example, a goniometer for measuring the wetting angle, for example of the Tantec brand. It is also possible to use an automatic measurement device, such as the drop tensiometer with optical bench from IT Concept. This is the case for the measurements which were carried out in the examples given below. The experiment consists in depositing a drop of water of calibrated volume that is equal to two microliters onto the clean and smooth surface of the sample using a syringe. The drop is lit by a uniform light source, of integrating sphere type, and the image of its profile is projected by a telecentric telephoto lens to a CCD camera. It is digitalized and then processed by software in order to determine, several times per second, the right and left contact angles defined as the angles between the plane formed by the support and the tangent planes on both sides of the base of the drop.

Typically, pure polypropylene has a contact angle with pure water of 105°.

The hydrophilizing agents according to the invention, when they are blended with the polypropylene thermoplastic polymer, make it possible to very significantly reduce this value, to levels between 70 and 85°.

Other aspects and advantages of the products which are the subject of the invention will appear in the light of the examples which are given below by way of illustration and that are in no way limiting.

Except where indicated otherwise, all the percentages given in the present application are weight percentages.

### EXAMPLE 1—PROCESSING OF THESE PRODUCTS

The constituents (94.9% of isotactic polypropylene homopolymer as granules sold by ATOFINA under the name PPH4060, 5% of hydrophilizing additive and 0.1% of IRGANOX B225 heat stabilizer) were introduced into the chamber of a “Brabender” brand internal mixer raised to a temperature of 150° C.

The chamber was equipped with two counter-rotating rotors of W50 thermoplastic type, rotating at a speed of 125 rpm. Taking into account internal shearing, the final temperature of the mixture was between 180° C. and 190° C. After a mixing time of 5 minutes, a filled polymer preform was extracted from the chamber, and was pressed in a mold having a thickness of 800 μm between two compression plates heated to 200° C. under 200 bar of pressure for 2 minutes. The mold was then cooled between two plates cooled to 18° C. under a pressure of 200 bar for 4 minutes.

After cooling and strengthening, these test pieces were the subject of various physicochemical tests intended to verify the hydrophilicity of their surface and the properties which result therefrom.

Remarks On The Processing And Effect Of Additives On The Molten Blends:

Various physical effects were noted during the mixing in the Brabender kneader, which could bring significant advantages to this preparatory phase.

Hydrophilizing Agents Used:

The 2 agents used are defined in the table (I) below:.

TABLE I
The Repel-o-tex SRP6 agent is a Rhodia product described
in the aforementioned WO 2006/056706.

| Notation | Structure of R” | Name |
|---|---|---|
| A | C^{₁₆}-C^{₁₈}alkyl and 2 EO, ionic | Ionized Rhodafac |
| | | PA32 |
| B | C^{₁₆}-C^{₁₈}alkyl and 5 EO, ionic | Ionized Rhodafac |
| | | PA35 |
| Control | Polyethylene glycol | Repel-o-tex SRP6 |
| C | polyester | |

### EXAMPLE 2—HYDROPHILIZING EFFECTS

They are given (via the measurement of the contact angle with distilled water) in table (II) below.

The measurements were carried out on the examples given below by using a drop tensiometer with optical bench known as SDT 200 from IT Concept.

The experiment consisted in depositing a drop of water of calibrated volume that was equal to two microliters onto the clean and smooth surface of the sample using a syringe. The drop was lit by a uniform light source, of integrating sphere type, and the image of its profile was projected by a telecentric telephoto lens to a CCD camera. It was digitalized and then processed by software in order to determine, several times per second, the right and left contact angles defined as the angles between the plane formed by the support and the tangent planes on both sides of the base of the drop. The result indicated in table (II) corresponds to the average of 10 to 15 measurements.

The results obtained are collated in table II below:

TABLE II
PP signifies polypropylene.

| Age of the test | Measurement at the |
|---|---|
| piece and treatment | time of mixing |
| Control PP without | 102° ± 2° |
| additive | |
| Control C | 65° ± 2° |
| PP + A | 42° ± 2° |
| PP + B | 26° ± 2° |

It is observed that the hydrophilicity of the surface is definitely obtained.

It is also observed that the hydrophilizing agents according to the invention are more active than the control C.

1-30. (canceled)

31. A process for hydrophilization of an organic plastic comprising contacting said organic plastic with an optionally polyalkoxylated phosphate ester in acid form or in salt form.

32. The process of claim 31, wherein the phosphate ester has the formula (I):
[R″—(O-A″)_{y}—O]_{x″}P(═O)(OM),_{x ′} (I)
wherein:
M comprises a proton, a cation, or a mixture;
x′ and x″ are equal to 1 or 2, provided that the sum of x′ and x″ is equal to 3;
y is an average value ranging from 0 to 100;
the R″ group, which is identical or different, represents a hydrocarbon-based radical comprising from 1 to 35 carbon atoms; and
the A″ groups, which are identical or different, represent a linear or branched alkylene radical comprising 2 to 4 carbon atoms.

33. The process of claim 32, wherein the R″ groups comprise a C₁—C₃₅ alkyl, alkylaryl, polyalkylaryl, or (polyarylalkyl)aryl group.

34. The process of claim 33, wherein said R″ groups comprise an alkyl or alkenyl radical bearing one or more ethylenic unsaturated groups, which are linear or branched, and comprise from 8 to 26 carbon atoms.

35. The process of claim 32, wherein said R″ groups comprise stearyl, oleyl, linoleyl or linolenyl, nonylphenyl, monostyrylphenyl, distyrylphenyl or tristyrylphenyl, or mixtures thereof.

36. The process of claim 32, wherein said (O-A″) groups comprise an oxyethylenated, oxypropylenated or oxybutylenated radical, or mixtures thereof.

37. The process of claim 31, wherein the plastic comprises a thermoplastic polymer, or a composition comprising a thermoplastic polymer.

38. The process of claim 37, wherein the thermoplastic polymer comprises a polyester, polyamide, polyolefin, or mixtures thereof.

39. The process of claim 38, wherein the thermoplastic polymer is based on polypropylene.

40. The process of claim 31, wherein said phosphate ester and said plastic form a composition.

41. The process of claim 40, wherein the plastic comprises a thermoplastic polymer in the form of a powder; an extruded and/or blow-molded and/or injection-molded article; or, a film, a fiber, a yarn, or a filament, optionally assembled as a woven or nonwoven textile surface.

42. The process of claim 40, wherein the weight ratio between the phosphate ester and the thermoplastic polymer ranges from 0.5/99.5 to 10/90.

43. The process of claim 41, further comprising melt-blending the phosphate ester with the thermoplastic polymer.

44. The process of claim 43, wherein said melt-blending comprises blending, the phosphate ester with the thermoplastic polymer, optionally with other ingredients, before melting, by direct introduction of the phosphate ester into the molten thermoplastic polymer, and/or via a masterbatch.

45. The process of claim 31, wherein contacting the plastic with the phosphate ester comprises applying a composition comprising the phosphate ester to all or a part of one surface of the plastic.

46. The process of claim 45, wherein the phosphate ester is applied as a solution comprising a solvent and a polyvinyl alcohol.

47. The process of claim 46, wherein the amount of polyvinyl alcohol ranges from 01 to 10% by weight of the solution comprising the solvent and the polyvinyl alcohol.

48. A composition comprising an organic plastic and a compound comprising an optionally polyalkoxylated phosphate ester in acid or salt form.

49. The composition of claim 48, wherein the phosphate ester has the formula (I):
[R″—(O-A″)_{y}—O]_{x″}P(═O)(OM)_{x′} (I)
wherein:
M comprises a proton, a cation, or a mixture;
x′ and x″ are equal to 1 or 2, provided that the sum of x′ and x″ is equal to 3;
y is an average value ranging from 0 to 100;
the R″ group, which is identical or different, represents a hydrocarbon-based radical comprising from 1 to 35 carbon atoms; and
the A″ groups, which are identical or different, represent a linear or branched alkylene radical comprising 2 to 4 carbon atoms.

50. The composition of claim 49, wherein the R″ groups comprise a C₁-C₃₅ alkyl, alkylaryl, polyalkylaryl, or (polyarylalkyl)aryl group.

51. The composition of claim 50, wherein said R″ groups comprise an alkyl or alkenyl radical bearing one or more ethylenic unsaturated groups, which are linear or branched, and comprise from 8 to 26 carbon atoms.

52. The composition of claim 51, wherein said R″ groups comprise stearyl, oleyl, linoleyl or linolenyl, nonylphenyl, monostyrylphenyl, distyrylphenyl or tristyrylphenyl, or mixtures thereof.

53. The composition claim 48, wherein said (O-A″) groups comprise an oxyethylenated, oxypropylenated or oxybutylenated radical, or mixtures thereof.

54. The composition of claim 48, wherein the plastic comprises a thermoplastic polymer, or a composition comprising a thermoplastic polymer.

55. The composition of claim 54, wherein the thermoplastic polymer comprises polyester, polyamide, polyolefin, or mixtures thereof.

56. The composition of claim 55, wherein the thermoplastic polymer is based on polypropylene.

57. The composition of claim 48, wherein said phosphate ester and said plastic form a composition.

58. The composition of claim 54, wherein the weight ratio between the phosphate ester and the thermoplastic polymer ranges from 0.5/99.5 to 10/90.

59. An article prepared from the composition of claim 58, wherein the plastic comprises a thermoplastic polymer in the form of a powder; an extruded and/or blow-molded and/or injection-molded article; or, a film, a fiber, a yarn, or a filament, optionally assembled as a woven or nonwoven textile surface.

60. The article of claim 59, wherein said article comprises a textile surface included in a baby diaper, a feminine hygiene product, or an adult incontinence product.
